(19) United States
(12) Patent Application Publication
(10) Pub. No.: US 2005/0206333 A1
(43) Pub. Date: Sep. 22, 2005

(54) Method for controlling a synchronized operation of at least two polyphase electric motors

(76) Inventors: Daniel Prudham, Thise (FR); Eric Rondot, Berthelange (FR); Jomal Tbatou, Besancon (FR)

Correspondence Address: EGBERT LAW OFFICES, 412 MAIN STREET, 7TH FLOOR, HOUSTON, TX, 77002, US

(21) Appl. No.: 10/515,721

(22) PCT Filed: Jul. 10, 2003
(86) PCT No.: PCT/FR03/02174

§ 371 Date: Nov. 24, 2004

(30) Foreign Application Priority Data
Jul. 30, 2002 (FR) 0209686

(51) Int. Cl. H02P 7/68

(52) U.S. Cl. 318/85

(57) ABSTRACT

A method is used for controlling a synchronized operation of at least two polyphase electric motors. Each motor includes a stator provided with electric coils and a rotor having N pairs of poles which are radially magnetized in an alternate direction. The method is characterized in that the position of the rotor of motors is determined with the aid of a detection; mechanism; one-time power supply sequencing for phases of the motors is defined with the aid of a logical synchronization electronic device: and the defined power supply sequencing is identically applied to the coils of the motors phases with the aid of a power electronic mechanism. A driving device for carrying out the method is also disclosed.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a process for controlling the synchronized operation of at least two multiphase electric motors with synchronized operation, each motor being provided with a stator portion provided with electrical coils and with a rotor with N pairs of poles radially magnetized in an alternate direction. The invention also relates to a driving device including at least two of these multiphase motors which means for detecting the position of said rotor and an electronic power unit for the current supply to the coils of each of their phases are associated with.

The present invention relates to the field of the synchronous brushless motors with permanent magnets at the rotor and windings at the stator.

### BACKGROUND OF THE INVENTION

Thus, FR-2.754.953 already discloses such a multiphase electric motor comprised, on the one hand, of a fixed portion or stator provided with electric coils and, on the other hand, of a moving portion or rotor. The latter has N1 pairs of poles radially magnetized in an alternate direction, N1 being equal to 4 or 5. As regards the stator, it includes N2 identical poles, N2 being equal to 9, so that these poles are spaced apart by 40°. They are furthermore grouped consecutively three by three, so that each phase is formed of a W-shaped circuit grouping three consecutive poles of the stator. The central pole of W-shape carries the winding of said phase. In addition, the central poles of two W-shaped circuits are angularly spaced apart by 120°.

For this type of motor, it is usual to detect the displacement of the mobile rotor portion in the magnetic circuit. In fact, these means for detecting the position of the rotor can adopt various embodiments, in particular that of an optical encoder, an induced-voltage detecting system, at least one magnetic element, etc.

Thus, starting from the known position of the rotor detected by the aforementioned means which an adequate logical electronic unit is associated with, an electronic power unit, generally formed of transistors, controls the current supply to the coils corresponding to the phases of the motor. More particularly, according to this position of the rotor, these phases are supplied with current according to selected sequences.

In fact, though such synchronous brushless motors find their application in many fields, increasingly more situations can be found in which one has to cause several of them to operate synchronously. Thus, in the field of the elevators and other hoisting devices, one should cite, by way of an example, EP-1.178.593, in which are used four of these synchronous brushless motors, mounted at the four corners of a platform, each motor having its electronic logical and power units. Furthermore, a speed signal proceeding from each motor is sent to a synchronization circuit. The latter compares these speeds two by two, whereby it should be known that through the result obtained is controlled the stoppage or the operation of a motor. In this respect, the control for the operation of a motor occurs through applying to the phases of the latter current-supply sequences according to a predetermined cycle.

In fact, this method does not allow to have a very accurate positioning and synchronism of all the motors, since the position of each rotor is not controlled directly by the synchronization circuit. Thus, it is possible, for example, that one of the rotors is ahead of the others by several electric turns (current-supply cycles of the phases), since the detection of the position of a rotor occurs only on one complete rotation of the rotor. In addition, this system requires a huge quantity of components, in particular, for each motor, an electronic logical unit controlling, based on the determination of the position of the rotor, the switching of the phases through their electronic power unit. A synchronization circuit finally completes this aggregate.

In addition, from EP-0 246 522 is known a control device for D.C. motors with electronic switching, these motors also including means for detecting the position of the rotor. Finally, the synchronized operation of two identical motors has to be ensured by feeding them according to a determined sequence as soon as is detected, through means for detecting the position of the rotors, that they are in the same position.

Thus, as shown in particular in this document EP-0 246 522, for a synchronous start, the corresponding phases of each motor are fed with an identical voltage, taking into consideration that the following phase of these motors is fed only when the means for detecting the position of the rotors detect that they are in the same phase relationship.

In brief, in this document the drivers are authorized to feed the phases of two motors according to a determined sequence at the start only when the signals proceeding from the encoder of the first motor are identical to the signals of the encoder of the second motor and the same applies to the following current-supply sequence.

If one of these signals is different from its counterpart, a switch blocks the drivers on the preceding sequence. Here, no offset is authorized.

### BRIEF SUMMARY OF THE INVENTION

Though the solution according to this state of the art finds its application in specific fields where a perfect synchronism between the motors is sought, the solution according to the invention pretends, though using one single electronic synchronization logical unit, to be economically more interesting and, in addition, of a broader application.

Thus, in a first inventive step, it has been possible to find out that, when an operation in parallel of several motors is sought, an offset of not more than half a rotation between the rotors of these motors results, most of the time and taking into consideration the usually associated reduction gears, into inconsiderable differences in the position of the organs that are finally controlled by these motors.

Furthermore, compared to EP-0 246 522, the solution according to the invention pretends to be capable of ensuring a smoother control of these motors, this by avoiding any risk that the motors intended to operate synchronously can be offset with respect to each other by more than one electric rotation.

Furthermore, since these multiple, synchronously operating motors very often find applications in products manufactured in mass production, such as the cars, the invention, through rationalized technical means of a simplified design, also allows coping with the difficulties experienced in these situations.

Thus, in the framework of an inventive step, there has been devised to associate with a multiple motor mounting one single electronic synchronization logical unit and to connect the latter to the means for detection the position of the rotors of each of these motors, in order to control, depending on this detected position of the rotors, according to the same current-supply sequence, the phases of each motor.

In brief, though, for synchronizing the motors, the predefined cycle of the current-supply sequences for the phases of one and/or another of them was hitherto simply interrupted, in this case, this cycle of the current-supply sequences for the phases of a motor is varying, since it depends on the position of his rotor with respect to the rotors of the other motors which are subjected to identical sequences of current supply for their phases.

It is obvious, under such circumstances, that the motors cannot be offset by an amplitude higher than one electric rotation, i.e. a normal cycle of current-supply for the phases. In addition, since the torque imparted to the rotor, even its putting into rotation or its stoppage is controlled depending on the sequence applied to an motor, this change, seen from a motor, in this cycle of current-supply sequences for its phases results, even more, into accelerations or decelerations of the rotation of its rotor than with simple orders to start or to stop.

Thus, the invention relates to a process for controlling the synchronized operation of at least two multiphase electric motors provided, each, with a stator portion provided with electric coils and a rotor with N pairs of poles radially magnetized in an alternate direction, characterized in that:
the position of the rotor of these motors is detected by detecting means;
a single sequence of current supply for the phases of the motors is defined by an electronic synchronization logical unit;
said defined sequence of current supply is applied to the coils of the phases of the motors in an identical way by means of at least one electronic power unit.

The invention also relates to a driving device for implementing the process, including at least two synchronously operating multiphase electric motors, each motor being provided with a stator portion provided with electric coils and with a rotor with N pairs of poles radially magnetized in an alternate direction, with these motors being associated means for detecting the position of their rotor and an electronic power unit for the current supply to the coils of each of their phases, this device also including an electronic synchronization logical unit connected to the means for detecting the position of the rotor of each of these motors, in order to control, depending on the detected position of the rotors, according to the same sequence of current supply, the phases of each motor.

The invention will be better understood when reading the following description with reference to the attached drawings.

### BRIEF DESCRIPTION OF THE SEVERAL VIEWS OF THE DRAWINGS

FIG. 1 is a schematic and synoptic view of a driving device according to the invention including two synchronous brushless motors.

FIG. 2 is a view identical to FIG. 1, corresponding to the case in which the motors are identical, allowing the use of one single electronic power unit.

FIG. 3 is a schematic view of an exemplary multiphase motor.

FIG. 4 shows the electric wiring diagram of the three phases of the motor and also the three Hall sensors forming the means for detecting the position of the rotor.

FIG. 5 is a vectorial representation of the three phases of the motor and the representation of the six angular sectors determined by the three position sensors.

### DETAILED DESCRIPTION OF THE INVENTION

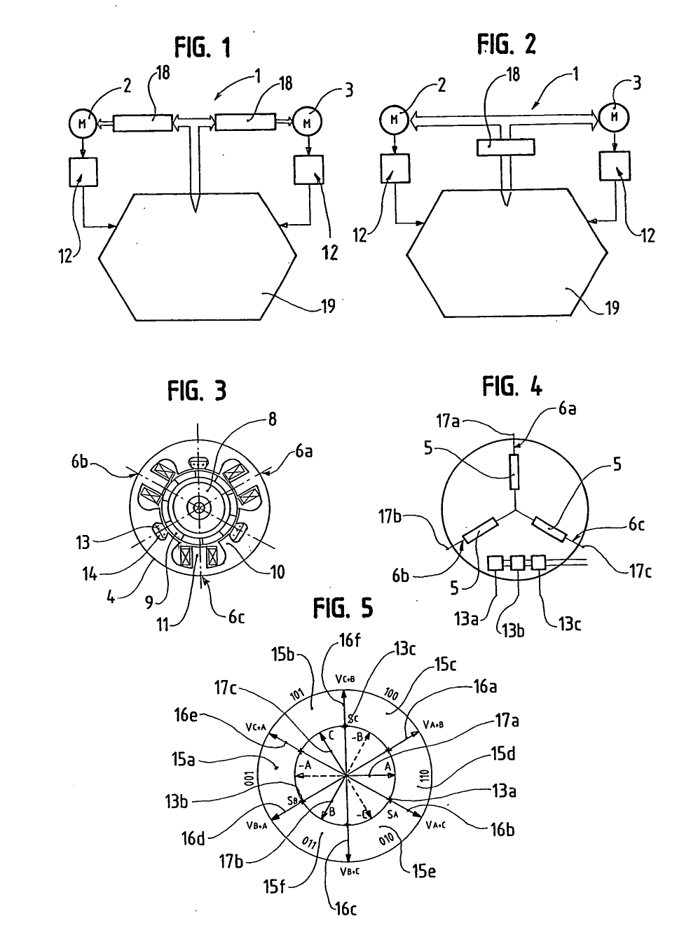

As shown in FIG. 1, the present invention relates to a driving device 1 integrating at least two synchronous brushless electric motors 2, 3 one embodiment of which is shown in FIG. 2, FIGS. 3 and 4 contributing to understanding its operation.

In particular, such a synchronous brushless electric motor is of the multiphase type and comprises a stator portion 4 excited by electric coils 5 corresponding to the various phases 6, taking into consideration that this motor 2, 3 also includes a rotor 8 with N pairs of rotor poles 9 radially magnetized in an alternate direction.

Within the framework of the embodiment corresponding to the figures of the attached drawing, N is equal to 5.

The stator portion 4 includes P poles 10. They are grouped consecutively three by three, so as to define a phase formed of a W -shaped circuit grouping three consecutive stator poles, the central stator pole 11 bearing the coil 3 of the corresponding phase 6.

Such a motor 2, 3 includes means 12 for detecting the position of the rotor 8, these means being shown in the drawings in the form of magnetic sensors, more exactly of Hall effect sensors 13. Advantageously, these detecting means 12 being positioned, between each of the phases 6, in a recess 14 equidistant between two consecutive stator poles 10 not belonging to the same phase 6.

FIG. 4 shows the electric wiring diagram of the three phases 6 of a motor 2, designated 6a, 6b, 6c, respectively, as well as the three Hall sensors 13, designated 13a, 13b, 13c, respectively. The star-shaped mounting of the windings 5 requires three output wires for the current supply for the phases 6. There are always two windings 5 supplied with current at the same time and a winding 5 in which no current flows.

In this embodiment using, as detecting means 12, Hall effect sensors 13, these have a common current supply and a common ground, hence a classical mounting with five dedicated wires.

FIG. 5 is a vectorial representation of the three phases 6a, 6b, 6c of the motor 2, 3 and the representation of the six angular sectors 15 determined by the three position-detecting elements 13 and designated 15a, 15b, 15c, 15d, 15e, 15f, respectively, in anti-trigonometric direction.

The three phases 6a, 6b, 6c are electrically offset by 120°. By using a bipolar current-supply mode, six stable positions are achieved in a pair of poles, here shown by means of the vectors 16a, 16b, 16c, 16d, 16e, 16f. For example, the vector 16a shows the stable position achieved by feeding the motor between the output wires 17a and 17b, the current flowing from 17a to 17b.

The switching points of the position detectors 13 are graphically located on the same vectors. Accordingly and through this type of mounting, the rotation of the motor is achieved by applying two by two to the coils of the phases successive current-supply sequences, well-known to the specialist in the art.

Finally, according to the invention the driving device 1, including at least two motors of this type 2, 3, is provided with at least one electronic power unit 18 for the current supply to their coils 5 of the phases 6, taking into consideration that it includes, furthermore, one single electronic synchronization logical unit 19 for their operation.

In particular, this electronic synchronization logical unit 19 is designed capable of controlling, depending on the position determined by the detection means 12 for the rotors 8 of each motor 2, 3, according to an identical current-supply sequence, the phases 6 of each of these motors 2, 3.

Thus, through the driving device 1 according to the invention, the motors 2, 3 do not include an own electronic logical unit controlled by an independent synchronization circuit to control the sequences of current supply for their phases. Indeed, in this case, there is only one electronic synchronization logical unit which is capable of applying to the motors only sequences of current supply for their phases which are necessarily identical.

Finally, one understands very well that none the motors 2, 3 intended at operating synchronously of the driving device 1 can be offset by more than one electric rotation with respect to the other motors.

In the case of the above-described three-phase motors 2, 3, this maximum electrical offset corresponds to a 180° rotation of the rotor 8.

Based on this observation and on the very principle of the operation of this type of synchronous brushless motor, the electronic synchronization logical unit 19 is designed capable of determining, depending on the detected position of their rotor 8, the sequence of current supply to be applied in an identical way to the phases 6 of these motors 2, 3.

More particularly, in this way the coils 5 of these motors 2, 3 are supplied with current in an identical, in order to achieve, as the case may be, a maximum torque at the level of the rotor of the delayed motor and, on the contrary, a reduced, even zero couple, at the rotor corresponding to the fast motor.

Finally, as is noted from the preceding description, the driving device according to the invention is not only of a very simple design, compared to the known devices, since it now includes only one electronic logical unit 19, but, in addition, it allows to guarantee a perfect synchronization of operation of the motors 2, 3, since no offset by more than one electric rotation can occur in this case.

It should be noted that, if the motors 2, 3 are in addition identical and designed capable of operating under the same voltage, the driving device can be limited to one single electronic power unit 18 for controlling all the motors, as appears in FIG. 2.

Furthermore, since, for a current supply in an identical way for the phases of the motors 2, 3, the position of each of their rotors is taken into consideration, the blocking of any of them for any reason whatsoever necessarily results into a current supply to these motors according to identical sequences, so that all the rotors are then maintained in a fixed position until the restoring of the failing motor.

The driving device according to the invention can find its application, typically, in the field of the control of the windscreen wipers of motor vehicles.

In this case, it very often occurs that there are several windscreen wiper brushes synchronously actuated by their own motors.

There are also known systems for adjusting pedal blocks of such a vehicle, which adjustment must be identical for each pedal. Therefore, to each of the latter is associated a motor. The various motors are designed capable of operating synchronously through the driving device according to the invention.

1. Process for controlling synchronized operation of at least two multiphase electric motors, each motor being comprised of, a stator portion, each stator portion being comprised of electric coils and a rotor with N pairs of poles radially magnetized in an alternate direction, said process comprising the steps of:
detecting a position of the rotor of the motors;
defining a single sequence of current supply for phases of the motors by an electronic synchronization logical unit; and
applying the defined sequence of current supply to the coils of the phases of the motors in an identical way by at least one electronic power unit.

2. Driving device for implementing the process according to claim 1, comprising:
at least two synchronously operating multiphase electric motors, each motor being comprised of a stator portion, said stator portion being comprised of electric coils and a rotor with N pairs of poles radially magnetized in an alternate direction; and
a means for detecting position of the rotor and an electronic power unit for the current supply to the coils of each of the phases, the means for detecting being associated with the motors; and
an electronic synchronization logical unit connected to the means for detecting the position of the rotor to control the phases of each motor, depending on detected position of the rotors, according to the sequence of current supply.

3. Driving device according to claim 2, further comprising:
at least two substantially identical multiphase electric motors; and
one single electronic power unit for controlling all motors through the electronic synchronization logical unit.
